(19) United States
(12) Patent Application Publication
(10) Pub. No.: US 2026/0211468 A1
(43) Pub. Date: Jul. 23, 2026

(54) MULTI-COMPARTMENT CHASSIS STRUCTURE

(71) Applicant: BEIJING DEEPCOOL SCI-TECH CO., LTD., Beijing (CN)

(72) Inventors: Edward XIA, Beijing (CN); Dongjin XU, Beijing (CN); Weichao LI, Beijing (CN)

(73) Assignee: BEIJING DEEPCOOL SCI-TECH CO., LTD., Beijing (CN)

(21) Appl. No.: 19/325,070

(22) Filed: Sep. 10, 2025

(30) Foreign Application Priority Data
Jan. 21, 2025 (CN) 202510092113.7

(51) Int. Cl. G06F 1/18; G06F 1/20

(52) U.S. Cl. CPC G06F 1/181; G06F 1/20

(57) ABSTRACT

The present disclosure discloses a multi-compartment chassis structure, including a plurality of compartments provided as being adjacent to each other, the plurality of compartments are configured to accommodate a plurality of electronic components, and the plurality of compartments are separated from one another by a space, which is configured as air intake channel for one of the compartments. The chassis structure according to the present disclosure is obtained by modifying a chassis structure by adopting a layered configuration to divide the original space of the chassis into two or more independent compartments. The CPU and graphics card, which generate much heat, may be isolated from the water cooling radiator and fans of CPU physically to achieve independent cooling, so that cooling efficiency is significantly improved.

### CROSS-REFERENCE TO RELATED APPLICATION

This application claims priority to Chinese Patent Application No. 202510092113.7, filed on Jan. 21, 2025, which is hereby incorporated by reference in its entirety.

### TECHNICAL FIELD

The present disclosure relates to the field of heat dissipation for electronic devices, and more specifically, to a multi-compartment chassis structure.

### BACKGROUND

In prior art of chassis, water cooling radiators are typically mounted at top of the chassis. As shown in FIGS. 1 to 4, fans on the water cooling radiator of the traditional chassis are generally mounted in a way of blowing air towards the radiator, so that air may pass through the water cooling radiator and be discharged outside of the chassis. As power consumption of graphics cards increases, such structure has a problem that the air is heated by the graphics card, so that the air entering the fan of the cooling radiator may be significantly hotter than room temperature. Additionally, the upward airflow interferes with the airflow of the graphics card, so that a temperature of the whole device increases and the cooling system operates with high load, and user experience may be degraded.

The information disclosed in this background part is only intended to provide a general understanding of the present disclosure and should not be considered as an acknowledgment or any form of implication that this information constitutes prior art known to those skilled in the art.

### BRIEF SUMMARY

The objective of the present disclosure is to provide a chassis structure with multiple compartments, which is obtained by modifying a chassis design into a layered configuration. The space inside a chassis in the art is divided into two or even more independent compartments, to isolate of water cooling from components such as the CPU and graphics card, which generate much heat, so that independent cooling may be achieved, and cooling performance may be improved.

To achieve the aforementioned objective, the present disclosure provides a multi-compartment chassis structure including a plurality of compartments provided as being adjacent to each other. The plurality of compartments are configured to accommodate a plurality of electronic components, and compartments are separated from one another by a space, which is configured as air intake channel for one of the compartments.

In a preferred embodiment, the plurality of compartments include a first compartment and a second compartment. The first compartment is configured to accommodate some of the plurality of electronic components, while the second compartment is provided above the first compartment and configured to accommodate some of the plurality of electronic components. A space between the first and second compartments is configured as an air intake channel for the second compartment.

In a preferred embodiment, the first compartment includes a top cover plate provided at top of the first compartment to block heat from the first compartment from flowing into the second compartment. The second compartment includes an upper cover provided at top of the second compartment and provided with ventilation holes. Airflow enters the second compartment through the air intake channel of the second compartment and exits through the ventilation holes of the upper cover, to form a cooling airflow path for the second compartment.

In a preferred embodiment, the multi-compartment chassis structure further includes a bridge provided between adjacent compartments. The bridge is configured to connect the first and second compartments and form a space therebetween.

In a preferred embodiment, the second compartment includes a second-compartment panel and a cover plate. The second-compartment panel is provided at front of the second compartment, while the cover plate is attached to rear of the bridge. A space enclosed by the cover plate and the bridge is configured to allow cooling tubes to pass therethrough.

In a preferred embodiment, the multi-compartment chassis structure further includes a bracket and connecting columns. The bracket is provided at top of the second compartment and is configured to connect the upper cover to the second compartment. The connecting columns are provided at the bridge and configured to secure the bridge between bottom of the second compartment and top of the first compartment.

In a preferred embodiment, the multi-compartment chassis structure further includes a water cooling radiator including a cooling water pipe and a cooling fan. The cooling fan is provided at top or bottom of the cooling water pipe, to generate an airflow flowing from the bottom to the top of the second compartment to form a cooling airflow path.

In a preferred embodiment, the multi-compartment chassis structure further includes a water cooling head attached to at least one heat source of the electronic components inside the first compartment. The water cooling head is connected to the cooling water pipe via cooling tubes.

In a preferred embodiment, the first compartment includes a left side plate, a right side plate, a first-compartment panel, a front fan, and a rear fan. The left side plate covers a left side of the first compartment, and the right side plate covers a right side of the first compartment. The front fan is provided at front of the first compartment, and the first-compartment panel covers the front side of the first compartment and is provided in front of the front fan. The rear fan is provided at rear of the first compartment. The front and rear fans are configured to form a cooling airflow path that runs through the first compartment from front to back.

In a preferred embodiment, the plurality of compartments further include a third compartment provided below the first compartment to accommodate some of the plurality of electronic components. The third compartment is connected to the first compartment via a bridge. The bridge forms a space between the third and first compartments, which is configured as an air intake channel for the third compartment.

In a preferred embodiment, the plurality of compartments include a first compartment and a second compartment. The first compartment is configured to accommodate some of the electronic components, while the second compartment is provided to one side of the top of the first compartment and is configured to accommodate some of the electronic components. Airflow moves from one side of the second compartment to the other side to form a cooling airflow path for the second compartment.

Compared to the prior art, the multi-compartment chassis structure provided by the present disclosure offers the following advantages: the chassis structure is modified by adopting a layered configuration to divide the original space of the chassis into two or more independent compartments. The water cooling radiator and fans of CPU are independently provided in an upper compartment, while the water cooling head and pump in a lower compartment are connected to the upper compartment via a hollow bridge. Hardwares such as the motherboard, power supply, and graphics card are provided in the lower compartment, so that the water cooling fan in the upper compartment may directly intake room-temperature air, and the CPU and graphics card, which generate much heat, may be isolated from the water cooling radiator and fans of CPU physically to achieve independent cooling without interference. The structure with a plurality of compartments leverages advantage brought by the heat conducting property of water cooling tubes by separating cooling components originally in one compartment into two or more compartments that can directly utilize room-temperature air for cooling, so that cooling efficiency is significantly improved.

### BRIEF DESCRIPTION OF THE DRAWINGS

FIGS. 1 to 4 are schematic structural views of the chassis structure according to an embodiment of the prior art.

FIG. 5 is an exploded perspective view of the chassis structure according to an embodiment of the present disclosure.

FIGS. 6 to 7 are another exploded perspective views of the chassis structure according to an embodiment of the present disclosure.

FIGS. 8 to 12 are schematic views showing how the cooling airflow of the upper compartment of the chassis structure goes according to an embodiment of the present disclosure.

FIG. 13A is a schematic view showing how the cooling airflow of the upper compartment of the chassis structure with single fan goes according to an embodiment of the present disclosure.

FIG. 13B is a schematic view showing how the cooling airflow of the upper compartment of the chassis structure with dual fans goes according to another embodiment of the present disclosure.

FIG. 13C is a schematic view of the cooling airflow direction of the upper compartment of the chassis structure with side-mounted water cooling radiators according to further embodiments of the present disclosure.

FIG. 13D is a schematic view of the cooling airflow direction of the upper compartment of the chassis structure with side-mounted water cooling radiators according to still another embodiments of the present disclosure.

FIGS. 14A to 14C are perspective structural views of a chassis structure with three compartments therein according to an embodiment of the present disclosure.

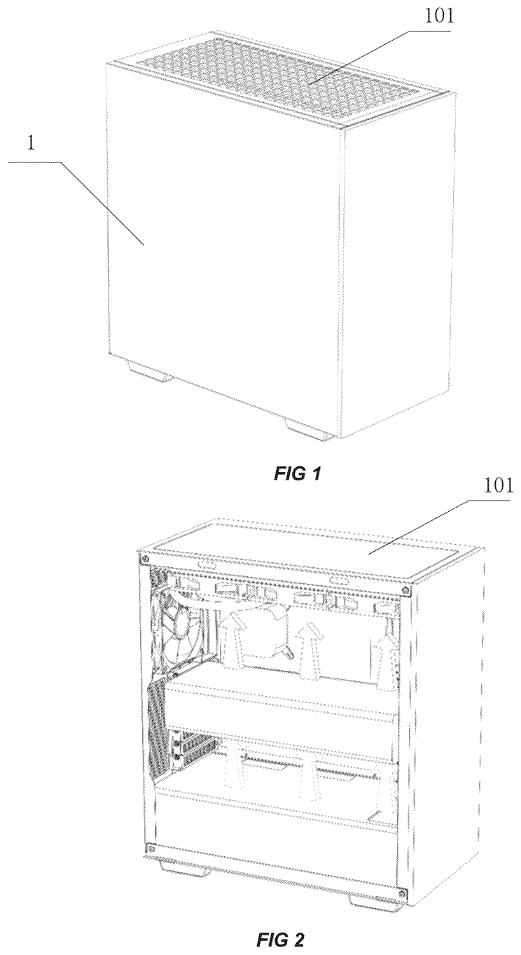

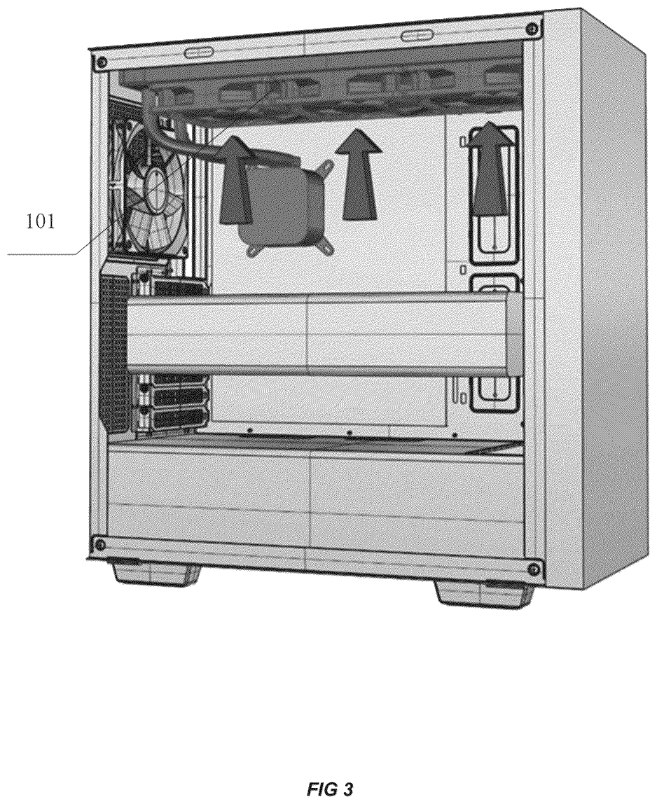

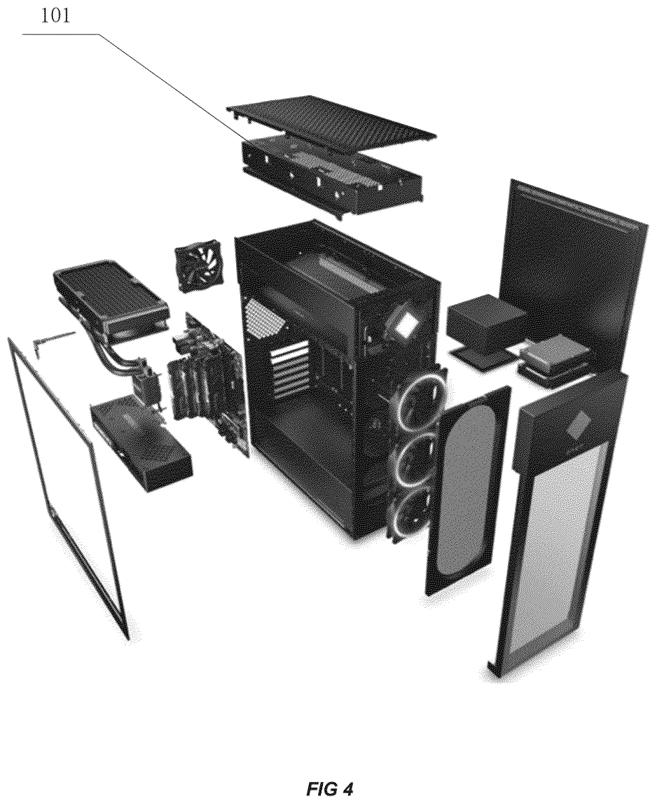

### MAIN REFERENCE NUMBERS

10—first compartment, 101—left side plate, 102—right side plate, 103—first-compartment panel, 104—top cover plate, 105—front fan, 106—rear fan, 107—support leg, 20—second compartment, 201—upper cover, 2011—ventilation hole, 202—bridge, 2021—connecting column, 203—cover plate, 204—bracket, 205—second-compartment panel, 30—third compartment, 40—water cooling head, 50—cooling tubes, 60—water cooling radiator.

### DETAILED DESCRIPTION

Detailed description would be made on preferred embodiments of the present disclosure in conjunction with the drawings. However, it should be understood that the scope of the present disclosure is not limited to these embodiments.

Unless otherwise stated explicitly, throughout the description and claims, the term “comprising” or variations thereof such as “comprises” or “includes” shall be understood to mean the inclusion of stated elements or components, but not the exclusion of other elements or components.

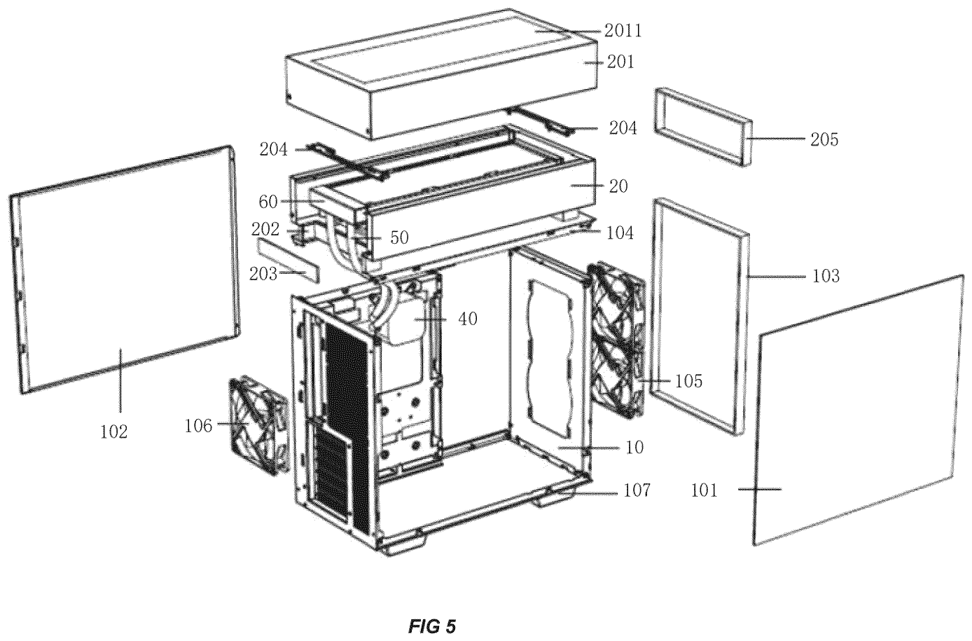

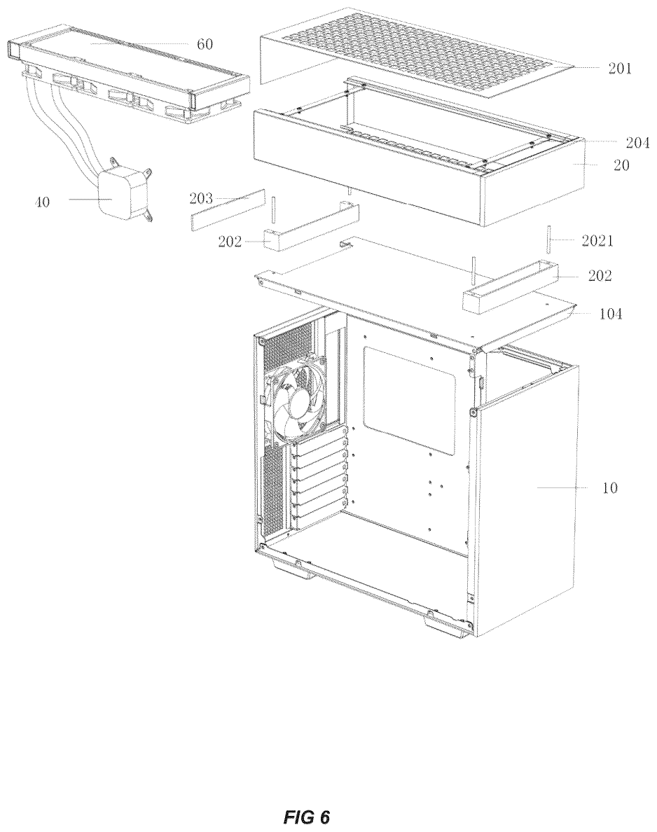

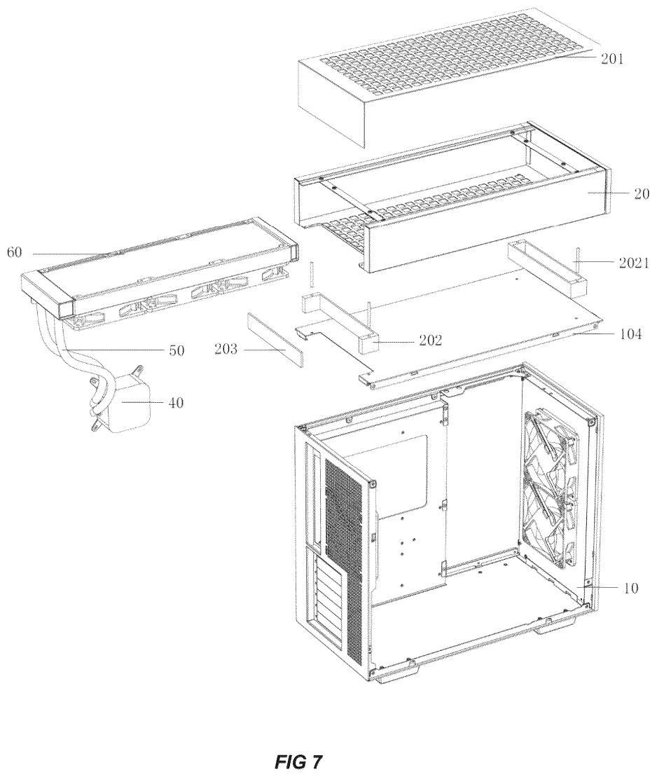

As shown in FIGS. 5 to 7, according to a preferred embodiment of the disclosure, the multi-compartment chassis structure includes a plurality of compartments provided to be adjacent to each other (stacked on one another or arranged horizontally, preferably configured to be stacked). The plurality of compartments are configured to accommodate a plurality of electronic components, including but not limited to, CPU, GPU, motherboard, graphics card, sound card, power supply, and water cooling radiator, or the like. A space is provided between the compartments and configured as an air intake channel for one of the compartments.

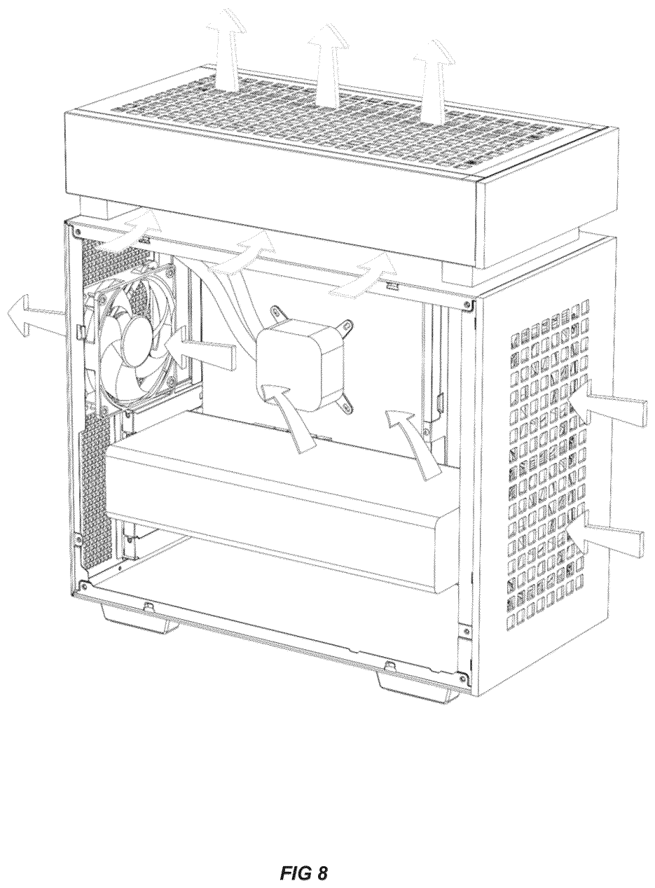

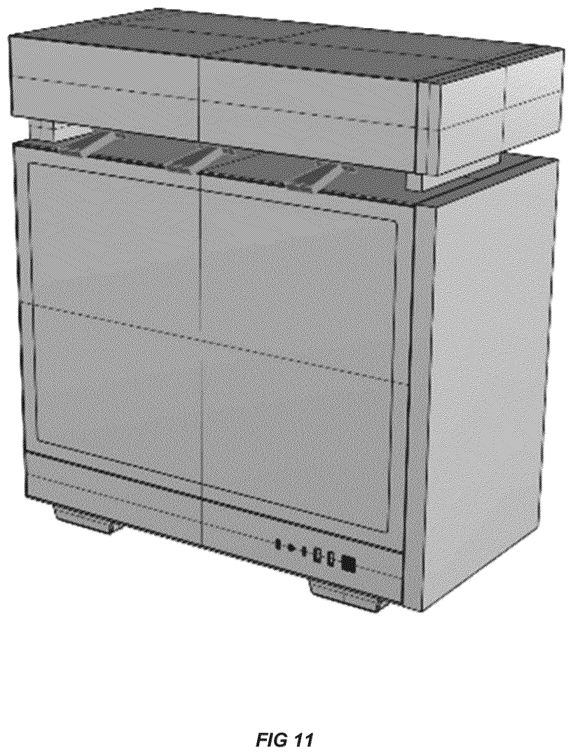

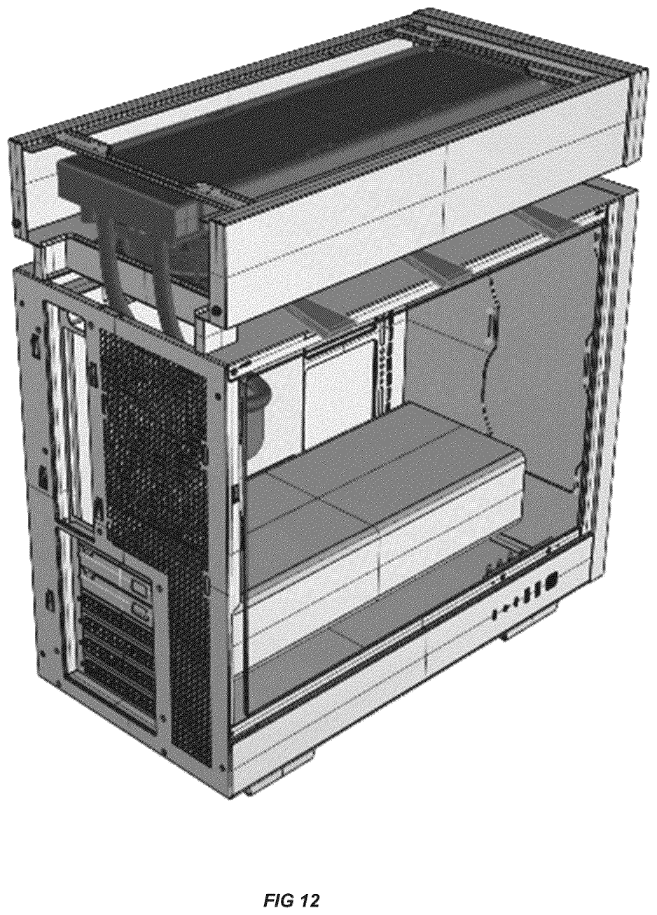

As shown in FIGS. 8 to 12, and in reference to FIGS. 5 to 7, in some embodiments, the plurality of compartments include a first compartment 10 and a second compartment 20. The first compartment 10 is configured to accommodate some of the electronic components (e.g., CPU, GPU, motherboard, graphics card, sound card, and power supply or the like). The second compartment 20 is provided above the first compartment 10 and is configured to accommodate some of the electronic components (e.g., water cooling radiators 60, which may include cooling water tubes and cooling fans or the like). A space between the first and second compartments may be configured as an air intake channel for the second compartment 20.

In some embodiments, the first compartment 10 includes a top cover plate 104 provided at top of the first compartment 10 and configured to block heat from the first compartment 10 from flowing into the second compartment 20. The second compartment 20 includes an upper cover 201 provided at top of the second compartment 20, which has ventilation holes 2011 therein. Airflow enters the second compartment 20 through its air intake channel, exits through the ventilation holes 2011 of the upper cover 201, to form a cooling airflow path for the second compartment 20.

In some embodiments, the multi-compartment chassis structure further includes a bridge 20 provided between adjacent compartments. The bridge is configured to connect the first compartment 10 and the second compartmented 20 and form a spacing therebetween.

In some embodiments, the second compartment 20 includes a second-compartment panel 205 and a cover plate 203. The second-compartment panel is provided at front of the second compartment 20, while the cover plate 203 covers the rear of the bridge 202. A space enclosed by the cover plate 203 and the bridge 202 may allow cooling tubes 50 to pass through. Additionally, the space enclosed by the cover plate 203 and the bridge 202 may be further configured for control lines or power lines to pass through. Control lines and power lines may alternatively pass through other locations, such as through holes (not shown in the drawings) in the top cover plate 104.

In some embodiments, the multi-compartment chassis structure further includes a bracket 204 and connecting columns 2021. The bracket 204 is provided at top of the second compartment 20 and configured to connect the upper cover 201 with the second compartment 20. The connecting columns 2021 are provided at the bridge 202 to secure the bridge 202 between the bottom of the second compartment 20 and the top of the first compartment 10. The bracket 204 and connecting columns 2021 are configured to primarily ensure the strength and stability of the connection between the first compartment 10 and the second compartmented 20.

In some embodiments, the multi-compartment chassis structure further includes a water cooling radiator 60 including cooling water pipes and cooling fans. The cooling fans are provided at top or bottom of the cooling water pipes, or at both top and bottom of the cooling water pipes, to generate an airflow flowing from the bottom of the second compartment 20 to the top of the second compartment 20 to form a cooling airflow path.

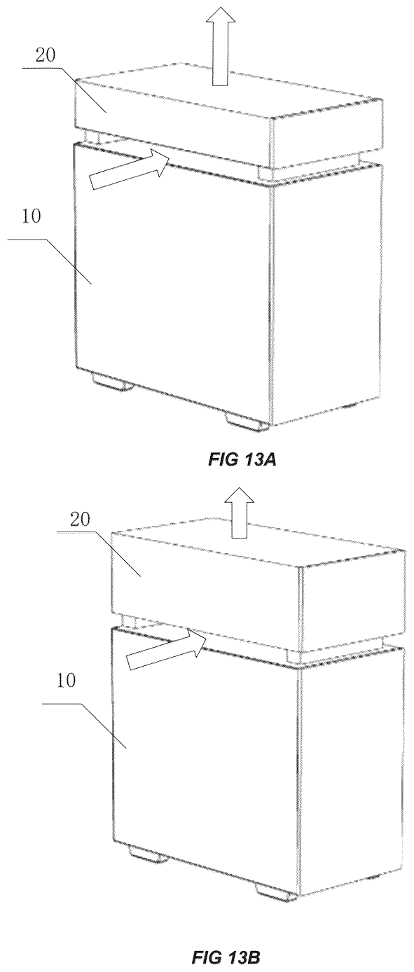

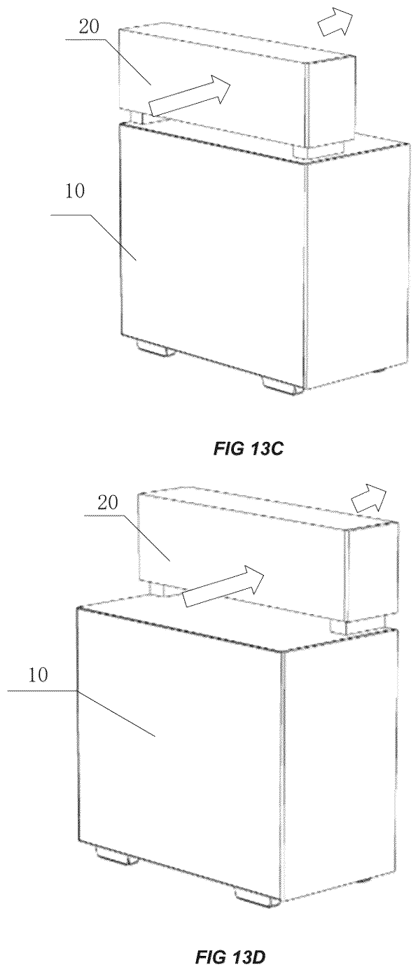

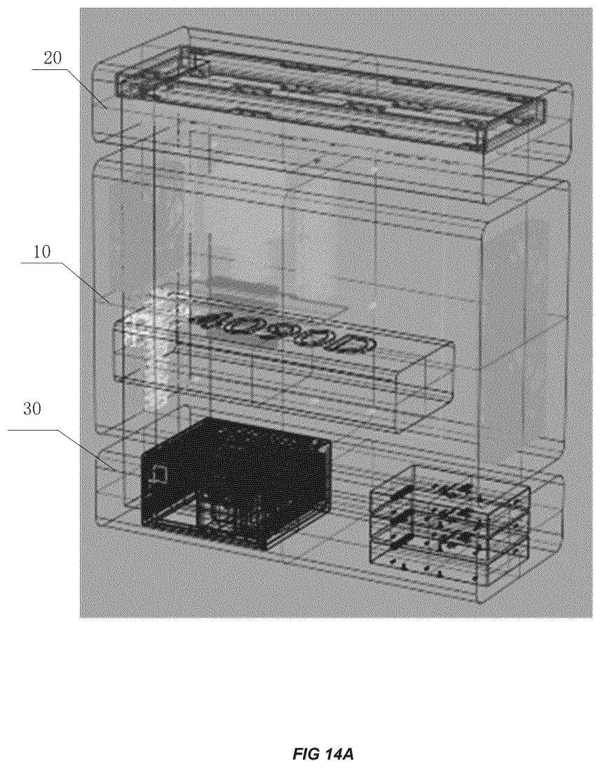

As shown in FIGS. 13A and 13B, in some embodiments, the embodiment shown in FIG. 13A illustrates a cooling water pipe equipped with a single set of cooling fans mounted at top or bottom of the cooling water pipe. The second compartment 20 in the embodiment shown in FIG. 13B has a thickness significantly greater than the second compartment 20 in the embodiment shown in FIG. 13A, as the cooling water pipe in the embodiment shown in FIG. 13B is equipped with two sets of cooling fans, provided at both the top and bottom of the cooling water pipe. The cooling fans provided at bottom blow air towards the cooling water pipe, while the cooling fans provided at top blow air away from the cooling water pipe. A single set or two sets of cooling fans are provided on the cooling water pipe according to the needs for cooling.

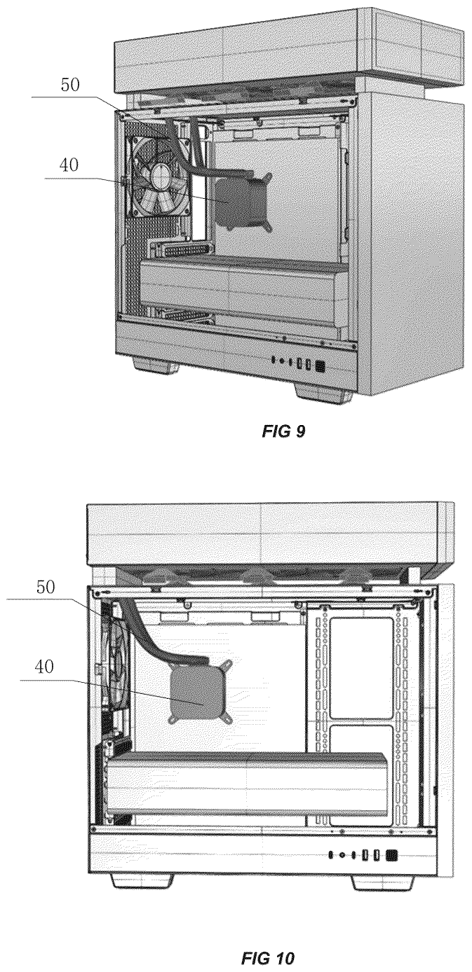

With reference to FIGS. 9 and 10, in some embodiments, the multi-compartment chassis structure further includes a water cooling head 40 attached to at least one heat source of the electronic components inside the first compartment 10. The water cooling head is connected to the cooling water pipe via cooling tubes 50. The water cooling head may be provided in plural, for example, but not limited to, provided at heat sources such as mainboard or graphic card respectively, each of a plurality of the water cooling heads 40 may be connected to the cooling water pipe via cooling tubes 50.

With reference to FIGS. 5 to 7, in some embodiments, the first compartment 10 includes a left side plate 101, a right side plate 102, a first-compartment panel 103, a front fan 105, and a rear fan 106. The left side plate 101 covers a left side of the first compartment 10, and the right side plate 102 covers a right side of the first compartment 10. The front fan 105 is provided at front of the first compartment 10, and the first-compartment panel 103 covers the front side of the first compartment 10 and is provided in front of the front fan 105. The rear fan 106 is provided at rear of the first compartment 10. The front fan 105 and rear fan 106 are configured to form a cooling airflow path that runs through the first compartment 10 from front to back.

As shown in FIGS. 13C and 13D, in some embodiments, the plurality of compartments include a first compartment 10 and a second compartment 20. The first compartment 10 is configured to accommodate some of the electronic components, while the second compartment 20 is provided to one side of the top of the first compartment 10 and is configured to accommodate some of the electronic components. Airflow moves from one side of the second compartment 20 to the other side to form a cooling airflow path for the second compartment 20. In the present embodiment, the cooling airflow from the water cooling radiator 60 flows from left to right or right to left, rather than from bottom to top. Additionally, the cooling water pipe may be equipped with a single set or two sets of cooling fans.

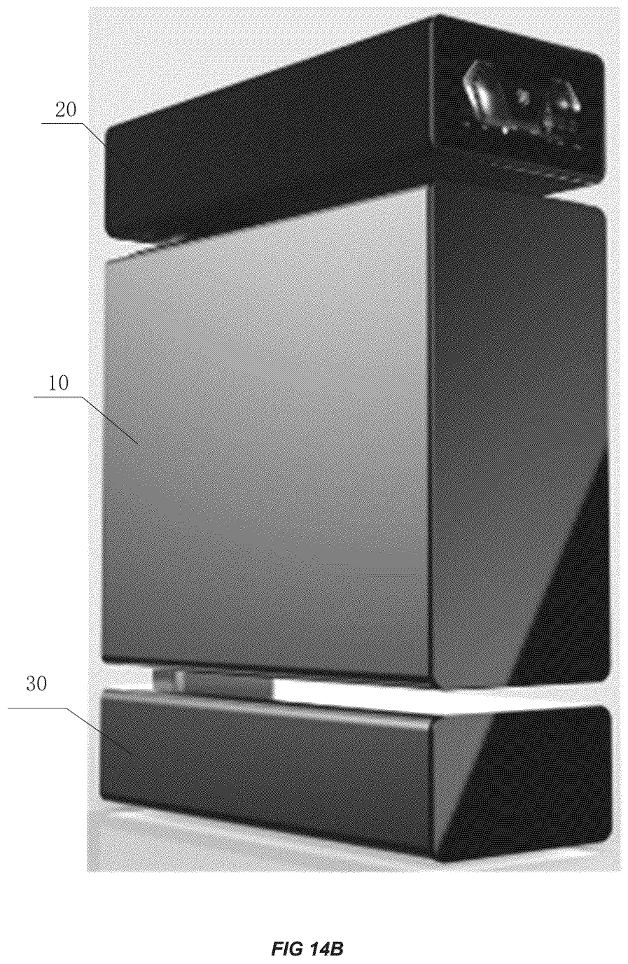

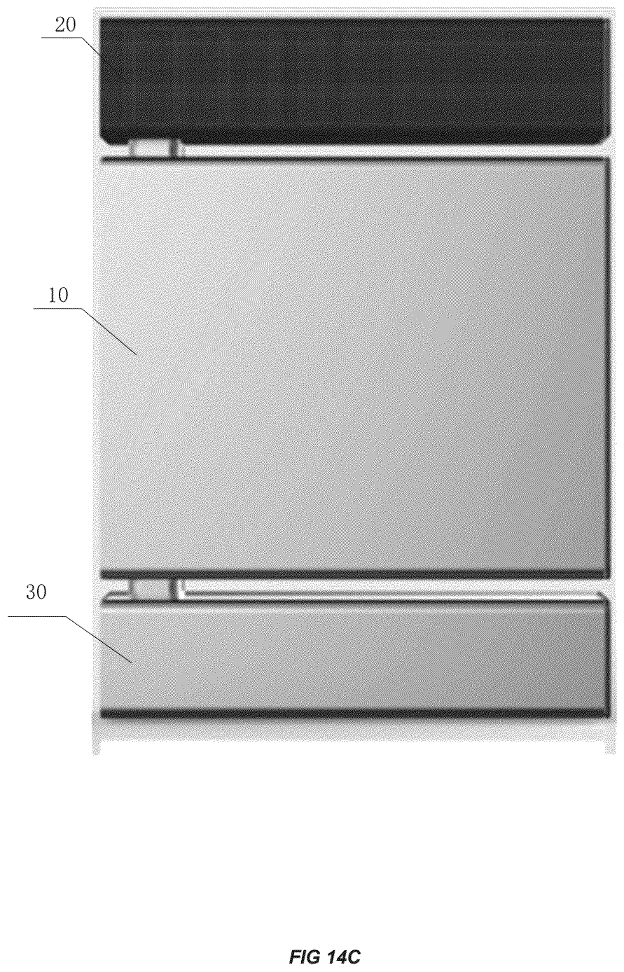

As shown in FIGS. 14A to 14C, in some embodiments, the plurality of compartments further include a third compartment 30 provided below the first compartment 10 to accommodate some of the plurality of electronic components, e.g., but limited to, power supply and fan of power supply or the like. The third compartment 30 is connected to the first compartment 10 via a bridge 202. The bridge 202 forms a space between the third compartment 30 and first compartment 10, which is configured as an air intake channel for the third compartment 30.

In summary, the multi-compartment chassis structure provided by the present disclosure offers the following advantages: the chassis structure is modified by adopting a layered configuration to divide the original space of the chassis into two or more independent compartments. The water cooling radiator and fans of CPU are independently provided in an upper compartment, while the water cooling head and pump in a lower compartment are connected to the upper compartment via a hollow bridge. Hardwares such as the motherboard, power supply, and graphics card are provided in the lower compartment, so that the water cooling fan in the upper compartment may directly intake room-temperature air, and the CPU and graphics card, which generate much heat, may be isolated from the water cooling radiator and fans of CPU physically to achieve independent cooling without interference. The structure with a plurality of compartments leverages advantage brought by the heat conducting property of water cooling tubes by separating cooling components originally in one compartment into two or more compartments that can directly utilize room-temperature air for cooling, so that cooling efficiency is significantly improved.

The description of exemplary embodiments of the present disclosure is for illustrative purposes. Such description is not intended to limit the disclosure to the specific forms as disclosed, and it is obvious that many modifications and variations can be made in light of the above teachings. The purpose of selecting and describing exemplary embodiments is to explain the particular principles of the disclosure and its practical applications, enabling those skilled in the art to implement and utilize various exemplary embodiments and various choices and modifications of the disclosure. The scope of the disclosure is intended to be defined by the claims and their equivalents.

1. A multi-compartment chassis structure, comprising a plurality of compartments provided as being adjacent to each other, the plurality of compartments are configured to accommodate a plurality of electronic components, and the plurality of compartments are separated from one another by a space, which is configured as air intake channel for one of the compartments.

2. The multi-compartment chassis structure according to claim 1, wherein the plurality of compartments comprise:
a first compartment, configured to accommodate some of the plurality of electronic components, and
a second compartment, provided above the first compartment and configured to accommodate some of the plurality of electronic components;
wherein a space between the first and second compartments is configured as an air intake channel for the second compartment.

3. The multi-compartment chassis structure according to claim 2, wherein the first compartment comprises a top cover plate provided at top of the first compartment to block heat from the first compartment from flowing into the second compartment; the second compartment comprises an upper cover provided at top of the second compartment and provided with ventilation holes, airflow enters the second compartment through the air intake channel of the second compartment and exits through the ventilation holes of the upper cover, to form a cooling airflow path for the second compartment.

4. The multi-compartment chassis structure according to claim 3, wherein the multi-compartment chassis structure further comprises a bridge provided between adjacent compartments, the bridge is configured to connect the first compartment and second compartment and form a space therebetween.

5. The multi-compartment chassis structure according to claim 4, wherein the second compartment comprises:
a second-compartment panel, provided at front of the second compartment; and
a cover plate, attached to rear of the bridge, a space enclosed by the cover plate and the bridge is configured to allow cooling tubes to pass therethrough.

6. The multi-compartment chassis structure according to claim 5, wherein the multi-compartment chassis structure further comprises:
a bracket, provided at top of the second compartment and is configured to connect the upper cover with the second compartment; and
connecting columns, provided at the bridge and configured to secure the bridge between bottom of the second compartment and top of the first compartment.

7. The multi-compartment chassis structure according to claim 5, wherein the multi-compartment chassis structure further comprises a water cooling radiator comprising a cooling water pipe and a cooling fan, the cooling fan is provided at top or bottom of the cooling water pipe, to generate an airflow flowing from the bottom of the second compartment to the top of the second compartment to form a cooling airflow path.

8. The multi-compartment chassis structure according to claim 7, wherein the multi-compartment chassis structure further comprises a water cooling head attached to at least one heat source of the electronic components inside the first compartment, the water cooling head is connected to the cooling water pipe via the cooling tubes.

9. The multi-compartment chassis structure according to claim 3, wherein the first compartment comprises:
a left side plate, covering a left side of the first compartment;
a right side plate, covering a right side of the first compartment,
a front fan, provided at front of the first compartment;
a first-compartment panel, covering the front side of the first compartment and provided in front of the front fan; and
a rear fan, provided at rear of the first compartment, wherein the front fan and the rear fan are configured to form a cooling airflow path that runs through the first compartment from front to back.

10. The multi-compartment chassis structure according to claim 2, wherein the plurality of compartments further comprises a third compartment provided below the first compartment to accommodate some of the plurality of electronic components,
wherein the third compartment is connected to the first compartment via a bridge, the bridge forms a space between the third compartment and the first compartment, which is configured as an air intake channel for the third compartment.

11. The multi-compartment chassis structure according to claim 1, wherein the plurality of compartments comprise:
a first compartment, configured to accommodate some of the electronic components; and
a second compartment, provided on one side of the top of the first compartment and configured to accommodate some of the electronic components;
wherein airflow moves from one side of the second compartment to the other side to form a cooling airflow path for the second compartment.
